(19) United States
(12) Patent Application Publication
(10) Pub. No.: US 2026/0095115 A1
(43) Pub. Date: Apr. 2, 2026

(54) AC Motor Control Device

(71) Applicant: Hitachi Astemo, Ltd., Hitachinaka-shi, Ibaraki (JP)

(72) Inventors: Wataru HATSUSE, Tokyo (JP); Toshiyuki AJIMA, Tokyo (JP); Shigehisa AOYAGI, Hitachinaka (JP); Takaya TSUKAGOSHI, Hitachinaka (JP)

(21) Appl. No.: 19/110,640

(22) PCT Filed: Aug. 25, 2023
(86) PCT No.: PCT/JP2023/030641

§ 371 Date: Mar. 11, 2025

(30) Foreign Application Priority Data
Nov. 11, 2022 (JP) 2022-180805

(51) Int. Cl. H02P 21/05; B60L 15/20

(52) U.S. Cl. CPC H02P 21/05; B60L 15/20; B60L 2220/10

(57) ABSTRACT

An alternating-current (AC) motor control device that is capable of suppressing current harmonic components flowing through an AC motor and reducing a loss generated in the AC motor can be achieved. The AC motor control device 10 includes a power converter 3 that performs power conversion from direct current (DC) power to AC power, and a control unit 2 that performs synchronous PWM control on the AC motor 1. The control unit 2 includes carrier wave generation units 221, 231, and 232 that generate carrier waves, and PWM pulse generation units 22 and 23 that generate PWM pulses based on the carrier waves and a voltage command value 21A. The carrier wave generation units 221, 231, and 232 each change a cycle of the carrier wave so that harmonic components in d-q orthogonal coordinates of the AC motor 1 are concentrated on a side of either a d axis or a q axis having a larger inductance, the harmonic components being included in the PWM pulse.

### TECHNICAL FIELD

The present invention relates to an alternating-current (AC) motor control device that drives an AC motor.

### BACKGROUND ART

In recent years, due to an increasing demand for energy saving, an AC motor control device that drives an AC motor has been applied to a wide variety of uses such as home appliances, infrastructures, and in-vehicle devices.

As such an AC motor control device that drives an AC motor, pulse width modulation (PWM) control is generally used. In the PWM control, a modulation signal is generated based on a voltage command signal applied to the AC motor, and a PWM pulse signal for turning on and off a switching element of a power conversion device is generated by comparing the modulation signal with a PWM carrier. This makes it possible to convert direct-current (DC) power into AC power for driving the AC motor.

In this way, by performing the PWM control, the DC power can be converted into the AC power, but since the operation for turning on and off the switching element of the power conversion device at high speed is repeated, an output voltage is applied in a pulse shape to the AC motor.

Therefore, a harmonic component is included in a current flowing through the AC motor, which causes a noise and a loss.

For example, PTL 1 and PTL 2 disclose techniques for reducing the noise and loss caused by on-off of the switching element of such a power conversion device.

In the method described in PTL 1, the cycle of a PWM carrier is changed with the lapse of time. Further, in the method described in PTL 2, the cycle of a PWM carrier near current zero crossing is shortened.

With such a method, the harmonic component of a voltage applied in a pulse shape to the AC motor is dispersed, so that the harmonic component of the current flowing through the AC motor can be dispersed. As a result, it has been proposed to reduce a noise generated in the AC motor and to suppress DC voltage fluctuation.

### CITATION LIST

### Patent Literature

PTL 1: JP 2010-41877 A
PTL 2: JP 2019-47688 A

### SUMMARY OF INVENTION

### Technical Problem

As described above, by performing the PWM control, there arises a problem that harmonic components are included in the current flowing through an AC motor, and noise and loss increase.

However, with the methods described in PTL 1 and PTL 2, the harmonic component of the voltage applied in a pulse shape to the AC motor can be dispersed, but a configuration in which the harmonic component of the current flowing through the AC motor is actively suppressed is not disclosed.

If the harmonic component of the current flowing through the AC motor is not suppressed, noise and loss caused by the harmonic component are difficult to reduced.

An object of the present invention is to achieve an AC motor control device capable of suppressing a harmonic component of a current flowing through an AC motor and reducing a loss caused in the AC motor.

### Solution to Problem

In order to achieve the above object, the present invention is configured as follows.

An AC motor control device includes a power converter that performs power conversion from DC power to AC power, and a control unit that performs synchronous PWM control on an AC motor. The control unit includes a carrier wave generation unit that generates a carrier wave, and a PWM pulse generation unit that generates a PWM pulse based on the carrier wave and a voltage command value. The carrier wave generation unit changes a cycle of the carrier wave so that harmonic components in d-q orthogonal coordinates of the AC motor are concentrated on a side of either a d-axis or a q-axis having a larger inductance, the harmonic components being included in the PWM pulse.

### Advantageous Effects of Invention

An object of the present invention is to achieve an AC motor control device capable of suppressing a harmonic component of a current flowing through an AC motor and reducing a loss generated in the AC motor.

### BRIEF DESCRIPTION OF DRAWINGS

FIG. 1 is a block diagram illustrating an overall configuration of an AC motor control device according to a first embodiment of the present invention.

FIG. 2 is a block diagram illustrating a PWM pulse generation unit according to the first embodiment of the present invention.

FIG. 3 is a diagram illustrating a waveform example in a case where a cycle of a carrier wave during synchronous PWM control is constant in a comparative example different from the present invention.

FIG. 4 is a diagram illustrating a waveform example in a case where a cycle of a carrier wave during synchronous PWM control is periodically changed in the first embodiment of the present invention.

FIG. 5 is a schematic relationship diagram between an orthogonal d-q-axis coordinate system and a voltage and current in vector control.

FIG. 6A is a diagram illustrating a harmonic component of an output voltage in a case where the cycle of the carrier wave is constant.

FIG. 6B is a diagram illustrating a harmonic component of an output voltage in a case where the cycle of the carrier wave is periodically changed.

FIG. 7A is a diagram illustrating a current harmonic component generated in a case where the voltage harmonic component illustrated in FIG. 6A is applied to a permanent magnet-embedded synchronous motor.

FIG. 7B is a diagram illustrating a current harmonic component generated in a case where the voltage harmonic component illustrated in FIG. 6B is applied to the permanent magnet-embedded synchronous motor.

FIG. 8 is a graph illustrating a change in a current harmonic component in a case where a cycle change amount is changed.

FIG. 9 is a diagram illustrating an example where an AC motor control device according to a second embodiment of the present invention is applied to an electric vehicle.

FIG. 10 is a configuration diagram of a PWM pulse generation unit according to the second embodiment.

### DESCRIPTION OF EMBODIMENTS

Embodiments of the present invention will be described below with reference to the drawings.

### EMBODIMENTS

### First Embodiment

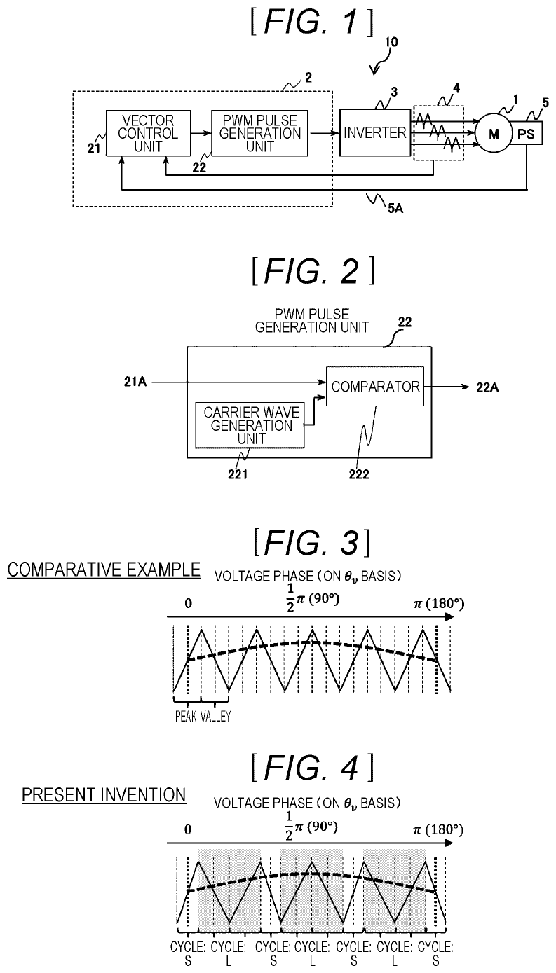

A first embodiment of the present invention will be described with reference to FIGS. 1 to 10.

The first embodiment describes an example in which an AC motor 1 is driven by an AC motor control device 10 of the present invention.

FIG. 1 is a schematic configuration diagram of the AC motor control device 10 according to the first embodiment. The AC motor control device 10 includes a control unit 2, an inverter (power converter) 3, and a current detection unit 4. The control unit 2 includes a vector control unit 21 and a PWM pulse generation unit 22. FIG. 2 is an explanatory diagram of the PWM pulse generation unit 22 included in the control unit 2. The PWM pulse generation unit 22 includes a carrier wave generation unit 221 and a carrier voltage command comparison unit 222.

The vector control unit 21 of the control unit 2 calculates a percentage modulation command value (voltage command value) 21A based on information from the current detection unit 4 that detects the current flowing through the AC motor 1 and information 5A from a position sensor 5 that detects the rotational position of the AC motor 1.

The PWM pulse generation unit 22 generates a PWM pulse 22A based on the calculated percentage modulation command value 21A. The inverter 3 performs power conversion from DC power to AC power based on the generated PWM pulse 22A, and supplies the AC power to the AC motor 1.

In the PWM pulse generation unit 22, as illustrated in FIG. 2, the carrier wave generation unit 221 generates a carrier wave such as a triangular wave, and the comparison unit 222 compares the generated carrier wave with the percentage modulation command value 21A to generate the PWM pulse 22A.

One of the methods for controlling the AC motor 1 using PWM pulses is a synchronous PWM control method. The control unit 2 performs synchronous PWM control on the AC motor 1.

FIG. 3 is a schematic diagram of a carrier wave and a percentage modulation command value during the synchronous PWM control in a comparative example different from the present invention. As illustrated in FIG. 3, in the synchronous PWM control method, the number of PWM carrier waves included in one rotation is fixed by changing the cycle of the PWM carrier wave in accordance with the rotation speed of the AC motor.

For example, the example illustrated in FIG. 3 shows a configuration in which a rise (peak) and a fall (valley) of the carrier wave each for 4.5 cycles are included in a half cycle (0° to 180°) of one rotation of an AC percentage modulation command, and the rise (peak) and the fall (valley) of the carrier wave each for 9 cycles, namely, a total of 18 cycles, are included in one rotation (0° to 360°) of the AC percentage modulation command.

Further, the cycle of the PWM carrier wave is generally set at a constant interval, and is referred to as synchronous 9-pulse control in the configuration of the example illustrated in FIG. 3.

In such a manner, the synchronous PWM control method provides an advantage that symmetry of a waveform is maintained and even harmonics are not generated. On the other hand, in order to fix the number of PWM carrier waves, a configuration is adopted in which a sideband wave (sixth and twelfth order components in the configuration of the example illustrated in FIG. 3) of a primary component and a voltage harmonic component of secondary components (18th order components in the configuration of the example illustrated in FIG. 3) of the carrier wave are greatly generated.

Further, when a voltage including such harmonic components is applied to the AC motor, a current harmonic component is generated also in the current due to an influence of these harmonic components.

In the first embodiment of the present application, in order to suppress the harmonic component of the current generated in the AC motor during the synchronous PWM control as in the example illustrated in FIG. 3, the cycle of the carrier wave during the synchronous PWM control is periodically changed.

FIG. 4 is a schematic diagram of a time of synchronous 9-pulse control under which a cycle of a carrier wave of synchronous PWM control is periodically changed in the configuration in the first embodiment of the present invention. As illustrated in FIG. 4, the cycle of the carrier wave is configured so that two cycles including a short cycle S and a long cycle L are repeated.

Specifically, assuming that the number of peaks and valleys of the synchronous PWM is P (P=9 in the case of FIG. 4) and the order of the cycles of the carrier wave is n, the cycle of the carrier wave is set to change in a sixth-order cycle as expressed in the following equation (1).

$$\begin{matrix}[ Mathematical Equation 1 ] & \\ {Δθ}_{PWM} ( n ) = \frac{2 \cdot π}{2 \cdot P} + C \cdot sin ( 6 \cdot \frac{2 \cdot π}{2 \cdot P} \cdot ( n - 1 ) - \frac{π}{2} ) & ( 1 )\end{matrix}$$

In the above equation (1), C integrated into a sinusoidal function is a value corresponding to a cycle change amount. Further, n is an order.

For example, when C=0 in the synchronous 9 pulses and the change in each cycle is 0, the cycle of the carrier wave is fixed to (2π/18)=20 [deg] as in the comparative example illustrated in FIG. 3. Further, when C>0 in synchronous 9 pulses, the following equations (2), (3), and (4) are established, and as in the present invention illustrated in FIGS. 4, n=1, 2, and 3 are repeated.

$$\begin{matrix}[ Mathematical Equation 2 ] & \\ {Δθ}_{PWM} ( 1 ) = \frac{2 \cdot π}{18} + C \cdot sin ( 6 \cdot \frac{2 \cdot π}{18} \cdot 0 - \frac{π}{2} ) = \frac{2 \cdot π}{18} + C \cdot sin ( \frac{2 \cdot π}{3} \cdot 0 - \frac{π}{2} ) & ( 2 )\end{matrix}$$

$$\begin{matrix}[ Mathematical Equation 3 ] & \\ {Δθ}_{PWM} ( 2 ) = \frac{2 \cdot π}{18} + C \cdot sin ( 6 \cdot \frac{2 \cdot π}{18} \cdot 1 - \frac{π}{2} ) = \frac{2 \cdot π}{18} + C \cdot sin ( \frac{2 \cdot π}{3} \cdot 1 - \frac{π}{2} ) & ( 3 )\end{matrix}$$

$$\begin{matrix}[ Mathematical Equation 4 ] & \\ {Δθ}_{PWM} ( 3 ) = \frac{2 \cdot π}{18} + C \cdot sin ( 6 \cdot \frac{2 \cdot π}{18} \cdot 2 - \frac{π}{2} ) = \frac{2 \cdot π}{18} + C \cdot sin ( \frac{2 \cdot π}{3} \cdot 2 - \frac{π}{2} ) & ( 4 )\end{matrix}$$

By changing the number P of the peaks and valleys of the synchronous PWM using the above equation (1), for example, the cycle change at the time of synchronous 15 pulses can be similarly set.

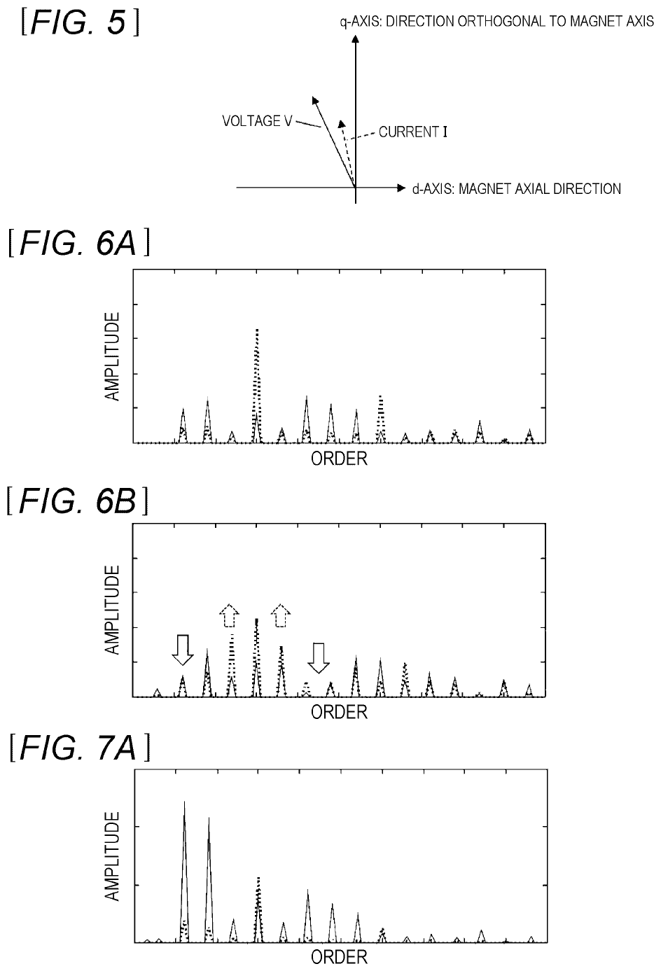

FIG. 5 is a diagram schematically illustrating d-q orthogonal coordinates and the voltage and current during vector control.

In FIG. 5, in the AC motor, the d-q orthogonal coordinates are set as coordinates in which the d-axis is along a magnet axis direction and a q-axis is orthogonal to the magnet axis direction. In the vector control, the voltage and current are controlled using such d-q orthogonal coordinates.

FIGS. 6A and 6B are diagrams illustrating harmonic components of output voltages in cases where the cycle of the carrier wave is constant and the cycle of the present application in periodically changed. FIG. 6A is the diagram in the case where the cycle is constant, and FIG. 6B is the diagram in the case where the cycle of the carrier wave in one embodiment is periodically changed.

In FIGS. 6A and 6B, horizontal axes represent orders, and the vertical axes represent amplitudes. Solid line components in FIGS. 6A and 6B are the above-described d-axis (magnet axis direction) components, and dotted lines indicate the above-described q-axis (magnet axis orthogonal direction) components.

In the case of the synchronous PWM control with a constant cycle in FIG. 6A, the component having the maximum amplitude is a secondary component of the q-axis component (dotted line). In addition, the d-axis component (solid line) component is generated on the right and left of the secondary component as sideband components of the primary component and the tertiary component.

Here, as illustrated in FIG. 6B, a result such that the harmonic component is changed is obtained by periodically changing the cycle. In FIG. 6B, it can be confirmed that the sideband components of the primary component and the tertiary component of the d-axis component (solid line) are reduced. Further, it can be confirmed that the components before and after the secondary component of the q-axis component (dotted line) are increased. In other words, in a voltage harmonic component configuration, the d-axis harmonic component is shifted to the q-axis harmonic component by periodically changing the cycle of the carrier wave.

Here, a voltage including the harmonic component illustrated in FIG. 6A or 6B is applied to the AC motor, and a current harmonic component caused by the voltage harmonic component is generated. The voltage and current related to the harmonic component have relationships as shown in the following equations (5) and (6) for the d-axis component (magnet axis direction) and the q-axis (magnet axis orthogonal component).

In the equation (5), idh (n) is a d-axis current, vdh (n) is a d-axis voltage, and Ldh is a d-axis inductance. Further, in the equation (6), iqh (n) is a q-axis current, vqh (n) is a q-axis voltage, and Lqh is a q-axis inductance.

$$\begin{matrix}[ Mathematical Equation 5 ] & \\ {i}_{dh} ( n ) = \frac{{v}_{dh} ( n )}{n \cdot ω \cdot {L}_{dh}} & ( 5 )\end{matrix}$$

$$\begin{matrix}[ Mathematical Equation 6 ] & \\ {i}_{qh} ( n ) = \frac{{v}_{qh} ( n )}{n \cdot ω \cdot {L}_{qh}} & ( 6 )\end{matrix}$$

The equations (5) and (6) above indicate that the harmonic current generated in the motor has a value obtained by dividing the harmonic current by the frequency and the inductance corresponding to the order of the harmonic voltage.

Here, in a main motor serving as a power source of an in-vehicle device, a permanent magnet-embedded synchronous motor is often used. In such a permanent magnet-embedded synchronous motor, the motor has a large saliency ratio in which the q-axis inductance shown in the above equation (6) is larger than the d-axis inductance shown in the above equation (5) (Ldh<Lqh). In other words, when voltage harmonics of the same amplitude are applied, the motor has a characteristic that the q-axis current harmonic component is smaller than the d-axis current harmonic component.

FIGS. 7A and 7B illustrate current harmonic components generated in a case where the voltage harmonic components illustrated in FIGS. 6A and 6B are applied to such a permanent magnet-embedded synchronous motor.

FIG. 7A is the diagram in the case where the cycle is constant, and FIG. 7B is the diagram in the case where the cycle of the carrier wave in one embodiment is periodically changed. In FIGS. 7A and 7B, horizontal axes represent orders, and the vertical axes represent amplitudes. Solid lines indicate the d-axis (magnet axis direction) components, and dotted lines indicate the q-axis (magnet axis orthogonal direction) components.

In the case of FIG. 7A illustrating the constant cycle, the secondary component of the q-axis component has the maximum voltage amplitude in the voltage harmonic component of FIG. 6A. However, since the q-axis inductance is large in the permanent magnet-embedded synchronous motor, the current amplitude of the q-axis secondary component has a small value in the current harmonic component of FIG. 7A, and the current harmonic amplitude of the sideband wave of the d-axis primary component has the maximum value.

Here, in the configuration of the first embodiment where the cycle of the carrier wave is periodically changed, as illustrated in FIG. 6B, the voltage harmonic component is shifted from the d-axis component to the q-axis component. Therefore, when the voltage according to one embodiment is applied to the permanent magnet-embedded synchronous motor, the d-axis current harmonic component decreases like the current harmonic component illustrated in FIG. 7B.

Further, since the q-axis inductance is large for the q-axis current harmonic component, the increase width is small, and the current harmonic component slightly increases. In other words, when the d and q axes are integrated, the entire current harmonic component can be suppressed.

As described above, the current harmonic component flowing through the AC motor can be suppressed by periodically changing the PWM carrier wave so that harmonic components in the d-q orthogonal coordinates of the AC motor, the harmonic components being included in the PWM pulse, are concentrated on the side of an axis having a larger inductance.

Further, since the current harmonic component is suppressed, the loss generated in the AC motor can be reduced.

Here, FIG. 8 is a schematic diagram in which a cycle change amount C of the above equation (1) is plotted on the horizontal axis and a root mean square (RMS value) of the current harmonic component is plotted on the vertical axis.

By increasing the cycle change amount C in the above equation (1), the d-axis voltage harmonic component can be shifted to the q-axis voltage harmonic component as described above, and the current harmonic component can be suppressed in the permanent magnet-embedded synchronous motor.

As a result, as illustrated in FIG. 8, the current harmonic component can be suppressed. However, as illustrated in FIG. 8, it can be confirmed that as the cycle change amount is increased, the distortion of the pulse waveform increases, and the current harmonic tends to increase. In other words, the RMS value of the current harmonic is a downward convex function having a minimum point (indicated by a circle in FIG. 8) with respect to the cycle change amount.

Therefore, in a case where the cycle of the carrier wave is periodically changed, the carrier wave generation unit 221 sets the cycle change amount C to be changed in the sixth order cycle to the point at which the RMS value of the current harmonic becomes minimum. This enables the AC motor to be driven in a state where the current harmonic component is suppressed.

In addition, by setting the vertical axis of FIG. 8 as the loss generated in the AC motor due to the current harmonic component, the cycle change amount C for minimizing the loss can be set. That is, the carrier wave generation unit 221 sets the cycle change amount to be changed in the sixth-order cycle to the cycle change amount for minimizing the loss generated in the AC motor due to the current harmonic component.

As a result, driving is enabled in a state where the loss generated in the AC motor due to the current harmonic component is suppressed.

In the synchronous PWM control, since the pulse cannot be changed below the cycle of the carrier wave, the cycle of the carrier wave is generally set as a control cycle.

Here, when the cycle change amount C is set to be large, the cycle change amount of the carrier wave increases, and a section having a long cycle is generated. In other words, since a region having a long control cycle is generated, it is necessary to slow a control response.

Therefore, for example, when a high-speed control response is required, the carrier wave generation unit 221 sets a value smaller than the cycle change amount C for minimizing the current harmonic component and the loss of the AC motor 1, thereby enabling driving while the suppression of the change between cycles and the suppression of slowness of the control response are balanced with the suppression of the current harmonic component and the loss.

As described above, according to the first embodiment of the present invention, the cycle of the carrier wave is changed at predetermined intervals so that the harmonic components in the d-q orthogonal coordinates of the AC motor included in the PWM pulse are concentrated on the side of an axis having the larger inductance, thereby achieving the AC motor control device 10 capable of reducing the loss generated in the AC motor.

### Second Embodiment

A second embodiment of the present invention will be described below.

The second embodiment describes an example of a case where the present invention is applied to an AC motor control device that controls an AC motor of an electric vehicle.

In the description of the second embodiment, illustration and description of parts common to those of the first embodiment are omitted.

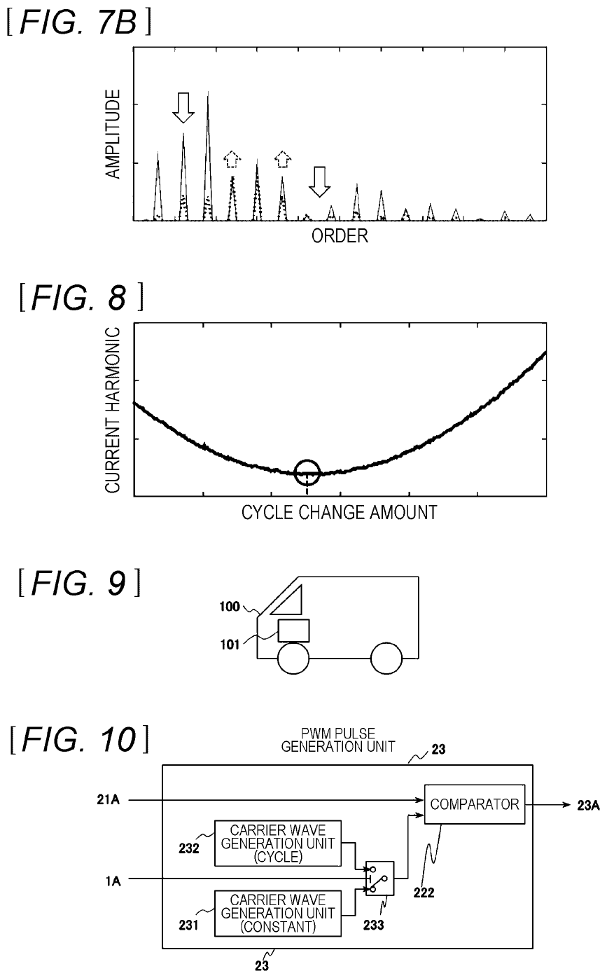

As illustrated in FIG. 9, by applying the control unit 2 described above to an electric vehicle 100 and using the AC motor 1 as an in-vehicle motor main engine 101, it is possible to provide the highly efficient electric vehicle 100 in which the current harmonic components and the AC motor are reduced.

When the in-vehicle motor main engine 101 used for an electric vehicle is started at an extremely low temperature, warm-up operation or the like may be performed because a rotating portion of the motor or the like is frozen. During such a warm-up operation, it is desirable that the loss generated from the motor is large.

Therefore, as illustrated in FIG. 10, in the PWM pulse generation unit 23 (a modification of the PWM pulse generation unit 2), a carrier wave switching unit 233 performs switching between the carrier waves generated by a carrier wave generation unit 231 (generates a carrier wave of a constant cycle) and a carrier wave generation unit 232 (changes the cycle of the carrier wave), based on AC motor temperature information 1A. The AC motor temperature information 1A can be output from a temperature sensor (not illustrated) that detects the temperature of the AC motor 1 to the carrier wave switching unit 233.

With such a configuration, when the AC motor temperature information 1A indicates a value smaller than or equal to a constant value, the carrier wave of the constant cycle on the carrier wave generation unit 231 side can be selected, and when the AC motor temperature information 1A indicates a value larger than or equal to the constant value, the periodically changed carrier wave on the 233 side can be selected. Thus, the loss generated from the AC motor 1 during the warm-up operation can be increased. The carrier wave generation unit 231 can be defined as a cycle-constant carrier wave generation unit.

Even when a heater for increasing the temperature of the AC motor 1 is separately provided, the warm-up operation can be started earlier by configuring the PWM pulse generation unit 23 as described above.

According to the second embodiment, the warm-up operation can be started earlier as described above in addition to the effect similar to that of the first embodiment can be produced.

In the above example, the q-axis inductance is larger than the d-axis inductance, but the present invention is also applicable to an example in which the d-axis inductance is larger than the q-axis inductance. In this case, the cycle of the PWM carrier wave is changed at a predetermined interval so that the harmonic components are concentrated on the side of the d-axis having the larger inductance.

### REFERENCE SIGNS LIST

1 AC motor
2 control unit
3 inverter
4 current detection unit
5 position sensor
10 AC motor control device
21 vector control unit
21A percentage modulation command value (voltage command value)
22 PWM pulse generation unit
23 modification of PWM pulse generation unit
100 electric vehicle
101 in-vehicle motor main engine
221 carrier wave generation unit
222 carrier-voltage command comparison unit
231 carrier wave generation unit (cycle-constant carrier wave generation unit)
232 carrier wave generation unit (cycle)
233 carrier wave switching unit

1. An alternating-current (AC) motor control device, comprising:
a power converter that performs power conversion from direct-current (DC) power to AC power; and
a control unit that performs synchronous pulse width modulation (PWM) control on an AC motor,
wherein the control unit includes a carrier wave generation unit that generates a carrier wave, and a PWM pulse generation unit that generates a PWM pulse based on the carrier wave and a voltage command value, and
the carrier wave generation unit changes a cycle of the carrier wave so that harmonic components in d-q orthogonal coordinates of the AC motor are concentrated on a side of either a d-axis or a q-axis having a larger inductance, the harmonic components being included in the PWM pulse.

2. The AC motor control device according to claim 1, wherein the carrier wave generation unit changes the cycle of the carrier wave in a sixth-order cycle.

3. The AC motor control device according to claim 2, wherein the carrier wave generation unit sets a cycle change amount for changing the cycle of the carrier wave in the sixth-order cycle to a cycle change amount for minimizing current harmonic components.

4. The AC motor control device according to claim 2, wherein the carrier wave generation unit sets a cycle change amount for changing the cycle of the carrier wave in the sixth-order cycle to a cycle change amount for minimizing a loss of the AC motor, the loss being generated due to current harmonic components.

5. The AC motor control device according to claim 3, wherein the carrier wave generation unit sets, in a case where a high-speed control response is requested, the cycle change amount for changing the cycle of the carrier wave in the sixth-order cycle to a change amount smaller than the cycle change amount for minimizing the current harmonic components or a loss of the AC motor, to suppress a decrease in the control response.

6. The AC motor control device according to claim 1, wherein the carrier wave generation unit changes the cycle of the carrier wave so that the harmonic components in the d-q orthogonal coordinates of the AC motor are concentrated on a side of the q-axis where an inductance is larger than on a side of the d-axis, the harmonic components being included in the PWM pulse.

7. The AC motor control device according to claim 1, wherein the AC motor control device is a control device that controls an AC motor of an electric vehicle.

8. The AC motor control device according to claim 7, wherein the PWM pulse generation unit further includes a carrier wave generation unit that generates a carrier wave of a constant cycle, a cycle-constant carrier wave generation unit that generates a carrier wave that periodically changes, and a carrier wave switching unit that performs switching between the cycle-constant carrier wave generation unit and the carrier wave generation unit.
